(19) United States
(12) Patent Application Publication
(10) Pub. No.: US 2014/0011556 A1
(43) Pub. Date: Jan. 9, 2014

(54) METHOD FOR PROVIDING A RHYTHM GAME, AND TERMINAL AND RECORDING MEDIUM THEREFOR

(71) Applicants: Byoung Su Kim, Seoul (KR); Won Man Lee, Yongin-si (KR); Tae Woong Kim, Seoul (KR); Min Young Kim, Seoul (KR)

(72) Inventors: Byoung Su Kim, Seoul (KR); Won Man Lee, Yongin-si (KR); Tae Woong Kim, Seoul (KR); Min Young Kim, Seoul (KR)

(73) Assignee: NEOWIZ GAMES CORPORATION, Seongnam-si, Gyeonggi-do (KR)

(21) Appl. No.: 14/006,984

(22) PCT Filed: Jan. 2, 2012
(86) PCT No.: PCT/KR12/00010

§ 371 Date: Sep. 24, 2013

(30) Foreign Application Priority Data
Mar. 25, 2011 (KR) 10-2011-0027151

(51) Int. Cl. A63F 13/10

(52) U.S. Cl. CPC A63F 13/10
USPC 463/7

(57) ABSTRACT

The present invention relates to a rhythm game, and more particularly, to a method for providing a rhythm game comprising attack and defense mechanisms, and to a terminal and recording medium therefor.

### TECHNICAL FIELD

The present invention relates to a rhythm game, and more particularly to a method, a terminal and a recording medium for providing a rhythm game where attacks and defenses can be performed.

### BACKGROUND ART

Recently, many rhythm games which have been developed refer to games, in each of which a user sees a note displayed on a game screen and manipulates the displayed note so as to coincide with a determined timing.

Such a conventional rhythm game employs a scheme where a user sees and manipulates a note displayed in a predetermined pattern by himself or by herself, and lacks diversity in terms of a scheme for displaying a note, types of notes, etc. Therefore, when the user repeatedly plays the conventional rhythm game, the user may easily lose interest.

### DISCLOSURE OF INVENTION

### Solution to Problem

Accordingly, the present invention has been made to solve the above-mentioned problems occurring in the prior art, and an object of the present invention is to provide a method, a terminal and a recording medium, which provide a rhythm game where attacks and defenses can be performed, so as to increase interest in the rhythm game.

Also, another object of the present invention is to provide a method, a terminal and a recording medium, which diversify types of notes, a scheme for displaying a note, etc., so as to increase interest in the rhythm game.

In order to accomplish these objects, there is provided a terminal for providing a rhythm game, the terminal including: a display controller for controlling display of a note on a game screen according to note pattern information designated and input for an attack; a touch signal input unit for receiving as an input a touch signal for manipulation of a note as a defense against the attack; and a judgment unit for judging an accuracy or a grade of the manipulation of the note based on input information of the touch signal and information on the display of the note.

In accordance with another aspect of the present invention, there is provided a method for providing a rhythm game by a terminal, the method including: receiving, as an input, note pattern information designated for an attack; controlling display of a note on a game screen according to the input note pattern information; receiving as an input a touch signal for manipulation of a note as a defense against the attack; and judging an accuracy or a grade of the manipulation of the note based on input information of the touch signal and information on the display of the note.

In accordance with another aspect of the present invention, there is provided a computer-readable recording medium recording a program for executing a method for providing a rhythm game, the program including the functions of: receiving, as an input, note pattern information designated for an attack; controlling display of a note on a game screen according to the input note pattern information; receiving, as an input, a touch signal for manipulation of a note as a defense against the attack; and judging an accuracy or a grade of the manipulation of the note based on input information of the touch signal and information on the display of the note.

Also, in accordance with another aspect of the present invention, there is provided a terminal for providing a rhythm game, the terminal including: a communication unit for setting a connection to a terminal of a defender defending against an attack; an attack designator for designating one or more attack points for the attack among multiple points on a game screen, and designating note pattern information on one or more notes to be displayed at the one or more designated attack points; and an attack transmitter for transmitting the designated note pattern information to the terminal of the defender.

In accordance with another aspect of the present invention, there is provided a method for providing a rhythm game by a terminal, the method including: setting a connection to a terminal of a defender defending against an attack; designating one or more attack points for the attack among multiple points on a game screen; designating note pattern information on one or more notes to be displayed at the one or more designated attack points; and transmitting the designated note pattern information to the terminal of the defender.

In accordance with another aspect of the present invention, there is provided a computer-readable recording medium recording a program for executing a method for providing a rhythm game, the program including the functions of: setting a connection to a terminal of a defender defending against an attack; designating one or more attack points for the attack among multiple points on a game screen; designating note pattern information on one or more notes to be displayed at the one or more designated attack points; and transmitting the designated note pattern information to the terminal of the defender.

According to the present invention as described above, the rhythm game where attacks and defenses can be performed is provided, so as to increase interest in the rhythm game.

Also, according to the present invention, types of notes, a scheme for displaying a note and the like are diversified, so as to increase interest in the rhythm game.

### BRIEF DESCRIPTION OF DRAWINGS

The above and other objects, features and advantages of the present invention will be more apparent from the following detailed description taken in conjunction with the accompanying drawings, in which:

FIG. 1 is a block diagram illustrating the configuration of a terminal for providing a rhythm game according to an embodiment of the present invention;

FIG. 2 is a view illustrating a game screen and buttons displayed on the game screen in a terminal for providing a rhythm game according to an embodiment of the present invention;

FIG. 3 is a view illustrating a change in the appearance of a typical note corresponding to a type of note;

FIG. 4 is a view illustrating a method for displaying a typical note and a method for manipulating the typical note;

FIG. 5 is a view illustrating a change in the appearance of a long touch note corresponding to another type of note;

FIG. 6 is a view illustrating a method for displaying a long touch note and a method for manipulating the long touch note;

FIG. 7 is a view illustrating a method for displaying a long note corresponding to another type of note and a method for manipulating the long note;

FIG. 8 is a view illustrating a change in the appearance of a circular arc-shaped note corresponding to another type of note;

FIG. 9 is a view illustrating a method for displaying a circular arc-shaped note and a method for manipulating the circular arc-shaped note;

FIG. 10 is a view illustrating another method for displaying a circular arc-shaped note and another method for manipulating the circular arc-shaped note;

FIG. 11 is a flowchart illustrating a method for providing a rhythm game according to an embodiment of the present invention;

FIG. 12 is a view illustrating a scheme for receiving, as input, note pattern information designated for an attack;

FIG. 13 is a view schematically illustrating a process of playing a rhythm game having a system of competition between users;

FIG. 14 is a block diagram illustrating the configuration of a terminal for providing a rhythm game according to another embodiment of the present invention; and

FIG. 15 is a flowchart illustrating a method for providing a rhythm game according to another embodiment of the present invention.

### MODE FOR INVENTION

In this specification, the term “rhythm game” refers to a game which receives, as input, note pattern information, configures a game screen so as to meet the received note pattern information and displays the configured game screen, receives as input a touch signal generated from the manipulation of a note by a user who views the displayed game screen, and judges, based on the received touch signal, how well a user has manipulated a relevant note.

Herein, “having received, as input, note pattern information” signifies “having come under an attack.” Also, “manipulation of a note” is an action of a user for touching a game screen, and signifies an action for defending against an attack. During the manipulation of a note as described above, music may be reproduced according to the selection of a user or setting information.

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

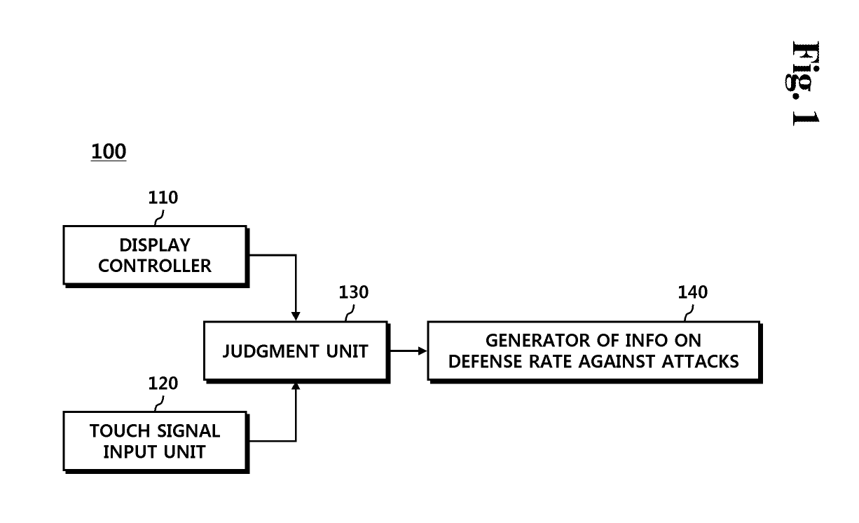

FIG. 1 is a block diagram illustrating the configuration of a terminal 100 for providing a rhythm game according to an embodiment of the present invention.

Referring to FIG. 1, a terminal 100 for providing a rhythm game according to an embodiment of the present invention includes a display controller 110 for controlling the display of a note on a game screen according to note pattern information designated and input for an attack, a touch signal input unit 120 for receiving as input a touch signal for the manipulation of a note as a defense against an attack, a judgment unit 130 for judging an accuracy or a grade of the manipulation of a note based on input information of the touch signal and information on the display of a note, etc.

As illustrated in FIG. 1, the terminal 100 for providing the rhythm game according to an embodiment of the present invention may further include a generator 140 of information on a defense rate against attacks for first generating information on a defense rate against attacks as information on how well a user has defended against the received attacks, upon receiving note pattern information as input, and then outputting or transmitting the generated information on a defense rate against attacks, when a result of the judgment has been determined by the judgment unit 130.

A button for notifying a position at which a user must manipulate a note, may be further displayed as well as the note as described above, as indicators displayed on the game screen. However, such a button may not be displayed according to types of notes.

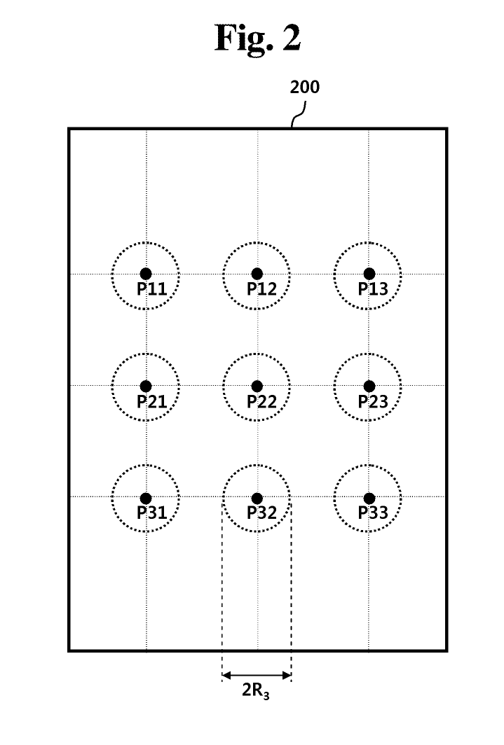

FIG. 2 is a view illustrating a game screen 200 and buttons displayed on the game screen 200 in a terminal 100 for providing a rhythm game according to an embodiment of the present invention.

Each button may be displayed at an optional point of the game screen 200.

Otherwise, as illustrated in FIG. 2, buttons may be displayed at multiple regularly arranged points P11, P12, P13, P21, P22, P23, P31, P32 and P33, respectively.

The number of buttons displayed on the game screen 200 may be differently adjusted according to the difficulty level of a game, etc.

Such a button may have a diameter which may be fixed or may change. In the following description, for convenience of description, it is assumed that a diameter of a button is fixed to 2R₃.

As described above, two types of indicators including a note and a button are displayed on the game screen 200. The user may receive a good result of the judgment only when the user sees these indicators, recognizes the timing of the manipulation of a note, a position at which the note is manipulated, a scheme for manipulating the note, etc., and manipulates the note so as to meet the manipulation timing, the manipulation point and the manipulation scheme.

The scheme for manipulating the note by the user greatly changes according to an indicator displayed on the game screen 200, particularly, how the note is displayed. Accordingly, in the rhythm game according to an embodiment of the present invention, various types of notes are used to further increase interest in the game.

In this specification, the types of notes, for example, include a typical note, a long touch note, a long note, a circular arc-shaped note, etc. In the following description, for each type of note, a method for displaying a note, a method for manipulating a note, a judgment method, etc. will be described in detail with reference to the relevant drawings.

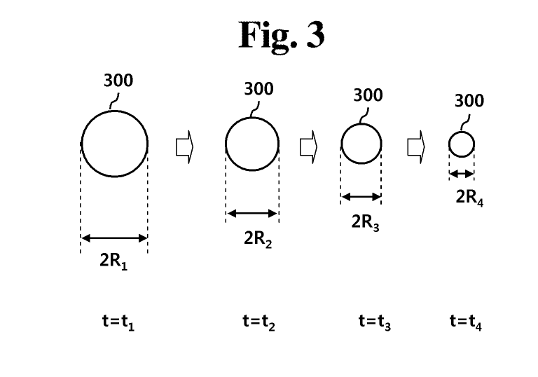

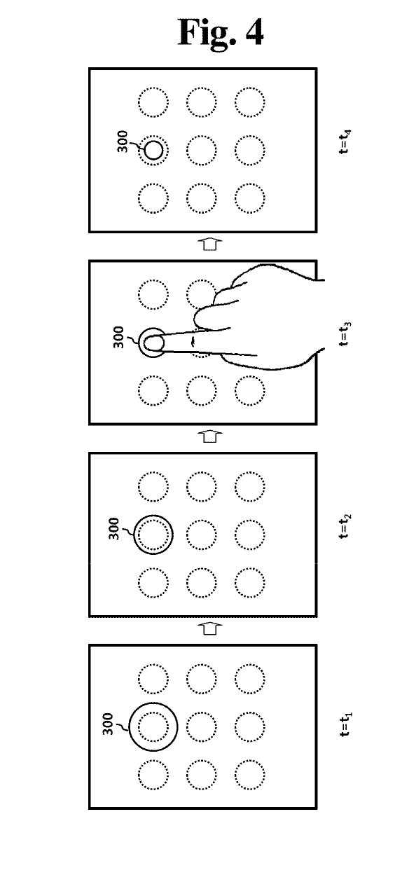

First, the most basic typical note among the types of notes will be described below with reference to FIG. 3 and FIG. 4.

FIG. 3 is a view illustrating a change in the appearance of a typical note 300 corresponding to a type of note.

As illustrated in FIG. 3, the typical note 300 may have a circular shape.

As illustrated in FIG. 3, the typical note 300 has a diameter which may change with the lapse of time after it begins to be displayed on the game screen 200.

Referring to FIG. 3, when a note is first displayed on a game screen 200 (when t=t₁), the typical note 300 has a diameter of 2R₁, and has a diameter which becomes gradually smaller with the lapse of time. Namely, when t=t₂, a diameter of the typical note 300 may become as small as 2R₂. When t=t₃, a diameter of the typical note 300 may become as small as 2

R₃. When t=t₄, a diameter of the typical note 300 may become as small as 2R₄ (R₁>R₂>R₃>R₄). Herein, when t=t₃, a diameter of the typical note 300 is equal to 2R₃, and the value of this diameter is equal to the value of a diameter of a button illustrated in FIG. 2.

FIG. 4 is a view illustrating a method for displaying a typical note 300 and a method for manipulating the typical note.

Referring to FIG. 4, the display controller 110 controls the display of the typical note 300 on the game screen 200, such as a changed appearance of the typical note 300 illustrated in FIG. 3.

When the display controller 110 controls the display of the typical note 300 on the game screen 200, it controls the display of the typical note 300 on the game screen 200, based on note pattern information designated and input for an attack. Accordingly, this note pattern information may include one or more of note position information, information on the number of notes, information on types of notes, information on a scheme for displaying a note, etc.

A method for displaying the typical note 300 as described above will be described in more detail as follows.

The display controller 110 may perform a control operation so as to previously display a button (a circle shown by a dotted line) at each of multiple points P11, P12, P13, P21, P22, P23, P31, P32 and P33 on the game screen 200, so as to select one or more defense points (P12 shown in FIG. 4) of multiple points P11, P12, P13, P21, P22, P23, P31, P32 and P33 according to the input note pattern information, and so as to display the typical note 300 at each of the one or more defense points selected as described above.

Also, with respect to a button (a button displayed at P12) and the typical note 300 displayed at each of the one or more selected defense points (P12 shown in FIG. 4), the display controller 110 may perform a control operation so as to first display the relevant button and the relevant typical note 300 as concentric circles having different diameters with the relevant defense point as the center, and may perform a control operation so as to make a timing (t=t₃) when the relevant button coincides with the relevant typical note 300, due to a diameter of the relevant typical note 300 which becomes equal to that of the relevant button while a diameter of at least one of the relevant typical note 300 and the relevant button changes (a diameter of the typical note 300 changes in FIG. 4) with the lapse of time.

Also, the display controller 110 performs a control operation so that a rate of change in diameter related to how quickly a diameter of the typical note 300 changes with time may change according to the difficulty level of a game, etc.

Also, the display controller 110 may perform a control operation so that one or more notes sequentially appear and are displayed at the one or more selected defense points, respectively. For example, when there are three defense points, the display controller 110 may perform a control operation so that time points, when three notes appear and are displayed at the three defense points respectively, differ from one another.

Referring to FIG. 4, in the method for displaying a note as described above, the user views the game screen 200, and only has to touch the relevant button (the button displayed at P12) at a time point closest to the timing (t=t₃) when the relevant typical note 300 coincides with the relevant button.

When the user manipulates the note in the method for manipulating the note as described above, the user may touch the relevant button (the button displayed at P12) at the timing (t=t₃) when the relevant typical note 300 exactly coincides with the relevant button. Otherwise, the user may touch the relevant button (the button displayed at P12) before or after the timing (t=t₃) when the relevant typical note 300 exactly coincides with the relevant button. Otherwise, the user may touch a button other than the relevant button (the button displayed at P12).

“Manipulation of a note” described in this specification signifies an action that the user touches the game screen 200. When such an action is sensed by the game screen 200 implemented by using a touch screen, a touch signal is generated, and the generated touch signal is input to the judgment unit 130.

In the following description, a judgment method performed by the judgment unit 130 will be described.

Referring to FIG. 4, the judgment unit 130 may obtain input information of a touch signal generated according to the manipulation of a note by the user and display information of the relevant typical note 300 through the touch screen, the display controller 110, etc. Then, based on the obtained input information of the touch signal and the obtained display information of the relevant typical note 300, the judgment unit 130 may determine how close a time point, when the touch signal has been input through the relevant button (the button displayed at P12), is to the timing (t=t₃) when the relevant typical note 300 exactly coincides with the relevant button. Next, the judgment unit 130 may judge an accuracy or a grade of the manipulation of the note according to a result of the determination.

Namely, the judgment unit 130 may detect a diameter of each of the relevant typical note 300 and the button at the time point when the touch signal is input. When the two diameters are equal, the judgment unit 130 may judge that the manipulation of the note by the user corresponds to the highest accuracy or the highest grade. On the other hand, when the two diameters are different, the judgment unit 130 may calculate how different the two diameters are, and may judge that the manipulation of the note by the user corresponds to an accuracy or a grade, which is lower than the highest accuracy or grade.

As described above, after a result of the judgment is determined by the judgment unit 130, the generator 140 of information on a defense rate against attacks receives, as input, note pattern information, and generates information on a defense rate against attacks as information on how well the user has defended against the received attacks based on the result of the judgment.

The generator 140 of information on a defense rate against attacks may calculate the frequency of attacks based on the number of notes displayed at one or more defense points selected from among multiple points P11, P12, P13, P21, P22, P23, P31, P32 and P33, respectively, and may generate information on a defense rate against attacks based on a result of the judgment of a note displayed at each of the one or more selected defense points and the calculated frequency of attacks. Then, the generator 140 of information on a defense rate against attacks may output the generated information on a defense rate against attacks on the game screen 200 or may transmit note pattern information, so as to enable the transmission of the relevant data to another terminal which has performed an attack.

The information on a defense rate against attacks may be calculated by using equation (1) below.

$$DR = \frac{1}{N} {\sum }_{i = 1}^{N} \frac{{s}_{i}}{S} \qquad ( 1 )$$

In equation (1), DR (Defense Rate) represents information on a defense rate against attacks, N which is the calculated frequency of attacks may be equal to the number of notes or may be a value calculated from the number of notes, S represents the highest judgment score which can be obtained as a result of judging one note once, and sᵢ represents a judgment score obtained as a result of judging the manipulation of the i^{th} note (the i^{th} attack).

For example, information on a defense rate against attacks is calculated by using equation (1) as follows. It is assumed that the frequency of attacks is equal to 5 and the highest judgment score is equal to 10 points. A judgment score at the first note is equal to 10 points. A judgment score at the second note is equal to 8 points. A judgment score at the third note is equal to 9 points. A judgment score at the fourth note is equal to 8 points. A judgment score at the fifth note is equal to 10 points. In this case, information on a defense rate against attacks, DR=(1/5)×(10/10+8/10+9/10+8/10+10/10)=0.9 (i.e. 90%).

Next, a long touch note corresponding to another type of note will be described below with reference to FIG. 3 and FIG. 4.

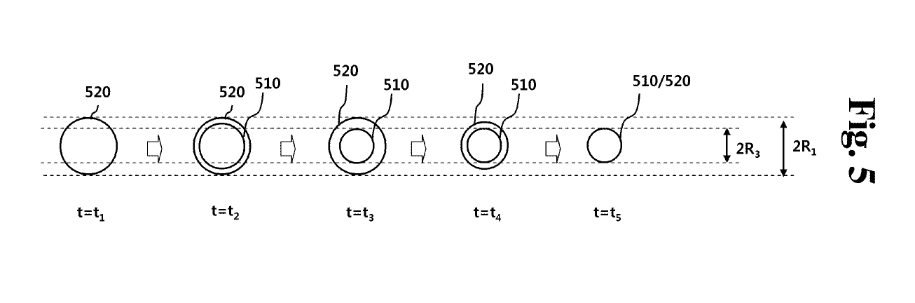

FIG. 5 is a view illustrating a change in the appearance of a long touch note corresponding to another type of note.

Referring to FIG. 5, the display controller 110 performs a control operation so as to previously display a button at each of multiple points P11, P12, P13, P21, P22, P23, P31, P32 and P33 on the game screen 200 as illustrated FIG. 2, so as to select one or more defense points of multiple points P11, P12, P13, P21, P22, P23, P31, P32 and P33 according to the note pattern information designated and input for an attack, and so as to simultaneously or sequentially display two circles 510 and 520 as one long touch note corresponding to another type of note, at each of the one or more selected defense points.

Namely, one long touch note includes two circles 510 and 520. In FIG. 5 illustrating a case when two circles 510 and 520 are sequentially displayed, a second circle 520 is first (t=t₁) displayed, and a first circle 510 is displayed when t=t₂.

Also, referring to FIG. 5, with respect to a button and two circles 510 and 520 displayed at each of one or more defense points selected from among multiple points P11, P12, P13, P21, P22, P23, P31, P32 and P33, the display controller 110 performs a control operation so as to display the relevant button and two circles 510 and 520 as concentric circles having different diameters with the relevant defense point as the center.

Then, the display controller 110 may perform a control operation so as to make a first timing when the first circle 510 coincides with the relevant button, due to a diameter of the first circle 510 which becomes equal to that of a relevant button while the diameter of the first circle 510 among the two circles 510 and 520 first changes. After the first timing, the display controller 110 may perform a control operation so as to make a second timing when the second circle 520 coincides with a relevant button, due to a diameter of the second circle 520 which becomes equal to that of a relevant button while the diameter of the second circle 520 among the two circles 510 and 520 changes.

The appearance of the long touch note, which changes under the control of the display controller 110 as described above, will be described with reference to an example as shown in FIG. 5. The display controller 110 displays the second circle 520 in such a manner that the second circle 520 has a diameter of 2R₁ when t=t₁, and displays the first circle 510 in such a manner that the first circle 510 has a diameter which is larger than a diameter (2R₃) of the button and is smaller than a diameter (2R₁) of the second circle 520 when t=t₂.

Then, the display controller 110 performs a control operation so that a diameter of the first circle 510 becomes smaller after t₂ and the diameter of the first circle 510 becomes equal to a diameter (2R₃) of the button when t=t₃. At this time, a time point of t=t₃ becomes a first timing when the first circle 510 and the relevant button become equal in a diameter of 2R₃ and thus the first circle 510 coincides with the relevant button.

After the first timing (t=t₃), the display controller 110 may perform a control operation so that a diameter of the second circle 520 becomes smaller and may identify that the diameter of the second circle 520 becomes smaller than 2R₁ which was the first diameter of second circle 520 when t=t₄. As described above, when t=t₅ while the diameter of the second circle 520 becomes smaller, the diameter of the second circle 520 becomes equal to a diameter (2R₃) of the button. At this time, a time point of t=t₅ becomes a second timing when the second circle 520 and the relevant button become equal in a diameter of 2R₃ and thus the second circle 520 coincides with the relevant button.

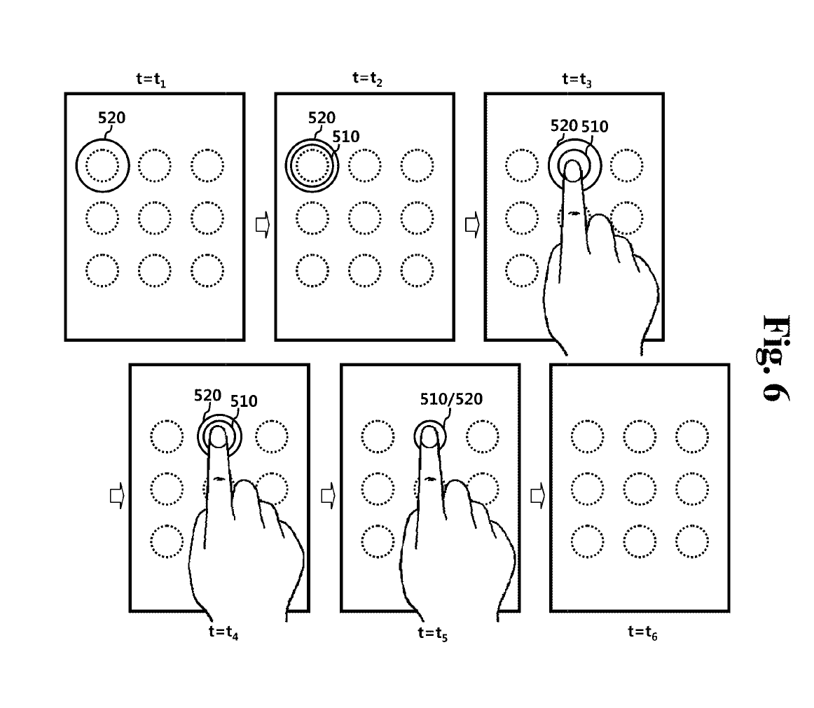

As described above, a long touch note is displayed on the game screen 200 in a method for displaying the long touch note corresponding to another type of note. Then, a user sees the displayed long touch note and manipulates the long touch note. Hereinafter, a method for manipulating a long touch note by the user, and a judgment method associated with the method for manipulating the long touch note, will be described with reference to FIG. 6.

FIG. 6 is a view illustrating a method for displaying a long touch note and a method for manipulating the long touch note.

Referring to FIG. 6, in order to accurately manipulate a long touch note displayed on the game screen 200 in the method for displaying a note as described above, the user must begin to touch a relevant button at a first timing (t=t₃) when a first circle 510 and a relevant button become equal in a diameter of 2R₃ and thus the first circle 510 coincides with the relevant button (a button displayed at P12 in FIG. 6), must keep the user's finger on the relevant button, and must take the user's finger off the relevant button at a second timing (t=t₅) when a second circle 520 and a relevant button become equal in a diameter of 2R₃ and thus the second circle 520 coincides with the relevant button.

The accurate manipulation of a note as described above may not be actually implemented. In order to judge an accuracy or a grade of the manipulation of a note as described above, the judgment unit 130 may obtain input information of a touch signal and display information of a long touch note through the touch signal input unit 120 and the display controller 110 or the touch screen. Then, based on the obtained input information of the touch signal and the obtained display information of the long touch note, the judgment unit 130 may determine how close a time point, when the touch signal begins to be input through the relevant button (a button displayed at P12 in FIG. 6), is to the first timing (t=t₃), and may determine how close a time period, during which the touch signal is maintained, is to the second timing (t=t₅). Next, the judgment unit 130 may judge an accuracy or a grade of the manipulation of the note according to a result of the determination.

As described above, after a result of the judgment is determined by the judgment unit 130, the generator 140 of information on a defense rate against attacks receives, as input, note pattern information, and generates information on a defense rate against attacks as information on how well the user has defended against the received attacks based on the result of the judgment.

The generator 140 of information on a defense rate against attacks may detect the frequency of attacks based on the number of long touch notes displayed at one or more defense points selected from among multiple points P11, P12, P13, P21, P22, P23, P31, P32 and P33, respectively, and may generate information on a defense rate against attacks based on a result of the judgment of a note displayed at each of the one or more selected defense points and the detected frequency of attacks. Then, the generator 140 of information on a defense rate against attacks may output the generated information on a defense rate against attacks on the game screen 200 or may transmit note pattern information, so as to enable the transmission of the relevant data to another terminal which has performed an attack. The above information on a defense rate against attacks may be calculated by using equation (1).

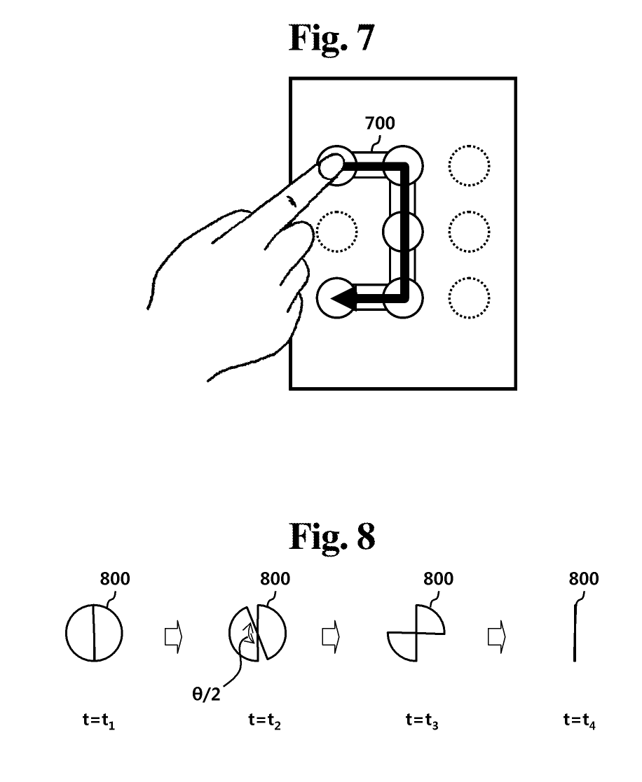

Next, a long note corresponding to another type of note will be described with reference to FIG. 7.

FIG. 7 is a view illustrating a method for displaying a long note 700 corresponding to another type of note and a method for manipulating the long note.

Referring to FIG. 7, according to note pattern information designated and input for an attack, the display controller 110 selects two or more defense points (P11, P12, P22, P32 and P31 shown in FIG. 7) of multiple points P11, P12, P13, P21, P22, P23, P31, P32 and P33 on the game screen 200, and displays a note which is one long note 700 (P11, P12, P22, P32 and P31 are connected in the order of them in FIG. 7) obtained by connecting the two or more selected defense points.

After the long note 700 is displayed on the game screen 200 in the method for displaying a note as described above, it is required that the user sees the long note 700, performs dragging along the trajectory of the long note 700 (a type of touch schemes), and manipulates a note.

With respect to the method for manipulating a note, the judgment unit 130 may obtain input information of a touch signal and display information of a long note through the touch signal input unit 120 and the display controller 110 or the touch screen. Then, based on the obtained input information of the touch signal and the obtained display information of the long note, the judgment unit 130 may determine whether the touch signal has been continuously input along the display trajectory of the long note 700. Next, the judgment unit 130 may judge an accuracy or a grade of the manipulation of a note according to a result of the determination.

As illustrated in FIG. 7, when a button is previously displayed at each of multiple points P11, P12, P13, P21, P22, P23, P31, P32 and P33 on the game screen 200, the judgment unit 130 may determine whether touch signals have been sequentially generated and have been input through buttons (P11, P12, P22, P32 and P31) existing on the trajectory of the long note 700, respectively. Next, the judgment unit 130 may judge an accuracy or a grade of the manipulation of the note according to a result of the determination.

At this time, in order to judge the manipulation of a note, a determination may be made as to how much length has been used to manipulate a note out of the total length of the long note 700 or as to how many notes have been manipulated among all buttons existing on the trajectory of the long note 700, so as to enable the determination of an accuracy or a grade.

As described above, after a result of the judgment is determined by the judgment unit 130, the generator 140 of information on a defense rate against attacks receives, as input, note pattern information, and generates information on a defense rate against attacks as information on how well the user has defended against the received attacks based on the result of the judgment.

The generator 140 of information on a defense rate against attacks may generate information on a defense rate against attacks based on a result of the judgment of the long note 700. Then, the generator 140 of information on a defense rate against attacks may output the generated information on a defense rate against attacks on the game screen 200 or may transmit note pattern information, so as to enable the transmission of the relevant data to another terminal which has performed an attack.

In this case, the information on a defense rate against attacks may be calculated as follows. First, a determination may be made as to how much length has been used to manipulate a note out of the total length of the long note 700 or as to how many notes have been manipulated among all buttons existing on the trajectory of the long note 700. Then, the information on a defense rate against attacks may be obtained from digitizing the obtained result of the judgment.

Meanwhile, when the display controller 110 displays one long note 700 obtained by connecting two or more defense points selected from among multiple points P11, P12, P13, P21, P22, P23, P31, P32 and P33, the total number of nodes, each of which represents between two points in all long notes displayed according to note pattern information, may be equal to or smaller than the predefined maximum frequency of attacks. The long note 700 illustrated in FIG. 7 has 4 nodes including a node between P11 and P12, a node between P12 and P22, a node between P22 and P32, and a node between P32 and P31.

Next, a circular arc-shaped note corresponding to another type of note will be described with reference to FIG. 8 to FIG. 10.

FIG. 8 is a view illustrating a change in the appearance of a circular arc-shaped note 800 corresponding to another type of note.

Referring to FIG. 8, according to note pattern information designated and input for an attack, the display controller 110 controls the display of the circular arc-shaped note 800 corresponding to another type of note so as to first (t=t₁) display a circular arc-shaped note 800 corresponding to another type of note as a circle, and so as to make a timing (t=t₄) when the shape of the circular arc-shaped note 800 becomes a straight line while the shape of the circular arc-shaped note 800 changes from a circle to a circular arc and becomes smaller in the area of the circular arc with the lapse of time after t t₁ as illustrated in FIG. 8.

Referring to FIG. 8, when the shape of the circular arc-shaped note 800 changes from a circle to a circular arc and becomes smaller in the area of the circular arc with the lapse of time after t=t₁, θ is gradually reduced from 2π (rad) to 0 (rad) and is equal to 0 (rad) when t=t₄. Herein, the length (L) of the circular arc may be defined by equation (2) below.

$$l = 2 π \cdot r \times \frac{θ}{2 π} = r θ \qquad ( 2 )$$

In equation (2), r represents the radius of a circle, and 0≦θ≦2π.

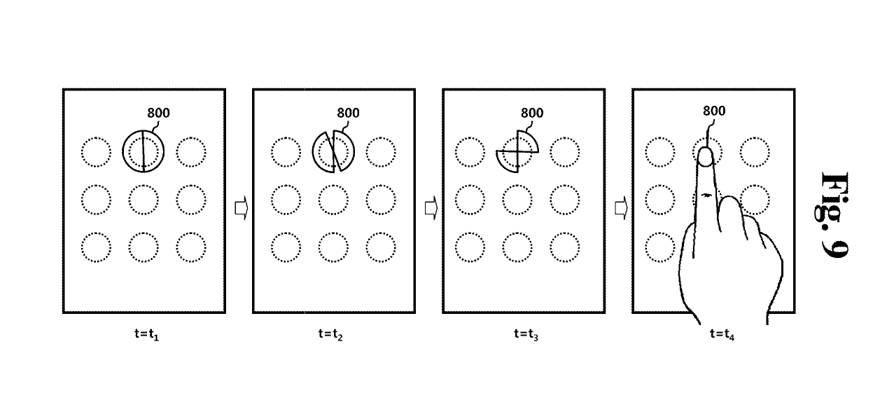

FIG. 9 is a view illustrating a method for displaying a circular arc-shaped note 800 and a method for manipulating the circular arc-shaped note.

Referring to FIG. 9, the display controller 110 selects one or more defense points (P12 shown in FIG. 9) selected from among multiple points P11, P12, P13, P21, P22, P23, P31, P32 and P33 on the game screen 200 according to note pattern information, and first (t=t₁) displays a circular arc-shaped note 800 as a circle having a radius of r. Thereafter, with the lapse of time, as illustrated in FIG. 9, the display controller 110 displays the circular arc-shaped note 800 in such a manner that the shape of the circular arc-shaped note 800 changes from a circle to a circular arc and becomes smaller in the area of the circular arc, and the length of the circular arc is equal to 0 and thus becomes a straight line when t=t₄.

In FIG. 9, a button may be displayed at each of multiple points P11, P12, P13, P21, P22, P23, P31, P32 and P33 on the game screen 200, as illustrated in FIG. 2.

A user views the game screen 200, on which the circular arc-shaped note 800 is displayed in the method for displaying a note as described above, and manipulates a note by touching a defense point (P12 shown in FIG. 9), at which the circular arc-shaped note 800 is displayed, so as to be closest to the timing (t=t₄) when the circular arc-shaped note 800 becomes a straight line.

When a button is displayed at each of multiple points P11, P12, P13, P21, P22, P23, P31, P32 and P33, the user manipulates a note by touching a button displayed at the relevant defense point (P12 shown in FIG. 9) at the timing (t=t₄) the circular arc-shaped note 800 becomes a straight line.

When a note has been manipulated in the method for manipulating a note as described above and a touch signal is input by the touch signal input unit 120, the judgment unit 130 may calculate the length (l) of the reduced circular arc at a time point of inputting the touch signal, may determine whether the calculated length (l) of the circular arc coincides with a predefined value, and may judge an accuracy or a grade of the manipulation of the note according to a result of the determination.

Although the predefined value as described above, accurately, may equal to zero corresponding to the length of the circular arc obtained when the circular arc-shaped note 800 becomes a straight line, the predefined value may be defined as a judgment reference value which is somewhat less strict such as “1” (not zero) for somewhat less strict judgment.

Also, the predefined values may be variously determined, a determination may be made as to which range the calculated length (l) of the circular arc belongs to among ranges between the predefined values, and an accuracy or a grade of the manipulation of a note may be judged.

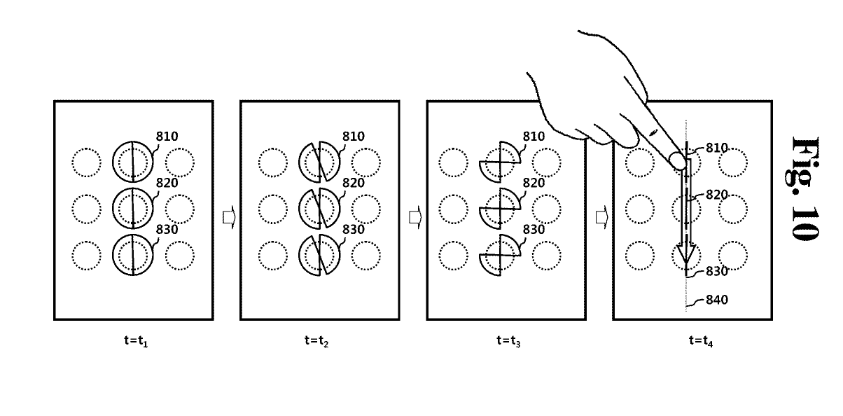

At an identical time point, on the game screen 200, one circular arc-shaped note 800 may be displayed as illustrated in FIG. 8 and FIG. 9, or multiple circular arc-shaped notes 810, 820 and 830 may be displayed as illustrated in FIG. 10.

FIG. 10 is a view illustrating another method for displaying multiple circular arc-shaped notes 810, 820 and 830 and another method for manipulating multiple circular arc-shaped notes 810, 820 and 830 when multiple circular arc-shaped notes 810, 820 and 830 are displayed at an identical time point.

Referring to FIG. 10, according to note pattern information designated and input for an attack, the display controller 110 may control the display of multiple circular arc-shaped notes 810, 820 and 830 so as to display each of multiple circular arc-shaped notes 810, 820 and 830 as a circle when t=t₁, and so as to make a timing (t=t₄) when all generated straight lines are displayed on straight line 840 while the shape of each of multiple circular arc-shaped notes 810, 820 and 830 changes from a circle to a circular arc and becomes smaller in the area of the circular arc, with the lapse of time.

The user views the game screen 200 on which multiple circular arc-shaped notes 810, 820 and 830 are displayed in the method for displaying a note as described above, and quickly performs dragging in the arrow direction along straight line 840, so as to manipulate a note, when the shapes of multiple circular arc-shaped notes 810, 820 and 830 all become straight lines and the straight lines are all displayed on straight line 840. Multiple circular arc-shaped notes 810, 820 and 830 displayed as described above may be called one scratch note.

When a note is manipulated in the method for manipulating the note as described above and a touch signal is input, the judgment unit 130 determines, based on input information of the touch signal and information on the display of the note, how close a time point, when the touch signal has begun to be input, is to the timing (t=t₄), and determines whether the touch signal is continuously input along straight line 840 within a predetermined time period. Then, the judgment unit 130 may judge an accuracy or a grade of the manipulation of the note according to a result of the determination. At this time, multiple circles all change to circular arcs, and the circular arcs all become smaller in the areas thereof and change to straight lines. At the timing (t=t₄), the straight lines are all displayed on one straight line 840.

As described above, after a result of the judgment is determined by the judgment unit 130, the generator 140 of information on a defense rate against attacks receives, as input, note pattern information, and generates information on a defense rate against attacks as information on how well the user has defended against the received attacks based on the result of the judgment.

Based on input information of a touch signal and information on the display of a note, the generator 140 of information on a defense rate against attacks may calculate the sum of straight line lengths of circular arc-shaped notes 810, 820 and 830 on straight line 840 as an attack length, may calculate, as a defense length, a length in which the touch signal is continuously input along the straight line within a predetermined time period, and may generate information on a defense rate against attacks based on the calculated attack length and the calculated defense length. Then, the generator 140 of information on a defense rate against attacks may output the generated information on a defense rate against attacks on the game screen 200 or may transmit note pattern information, so as to enable the transmission of the relevant data to another terminal which has performed an attack.

The terminals 100 according to an embodiment of the present invention as described above may either be portable communication terminals including a smart phone, a mobile communication terminal, etc., may be game dedicated terminals including a game console, a game device, etc., or, in some cases, may be computers including a desktop computer, a laptop computer, etc.

Also, the elements 110, 120 and 130 included in the terminal 100 as illustrated in FIG. 1 may be implemented as software modules, and may perform their functions by using hardware elements such as a touch screen, a memory, a processor, etc. included in the terminal 100.

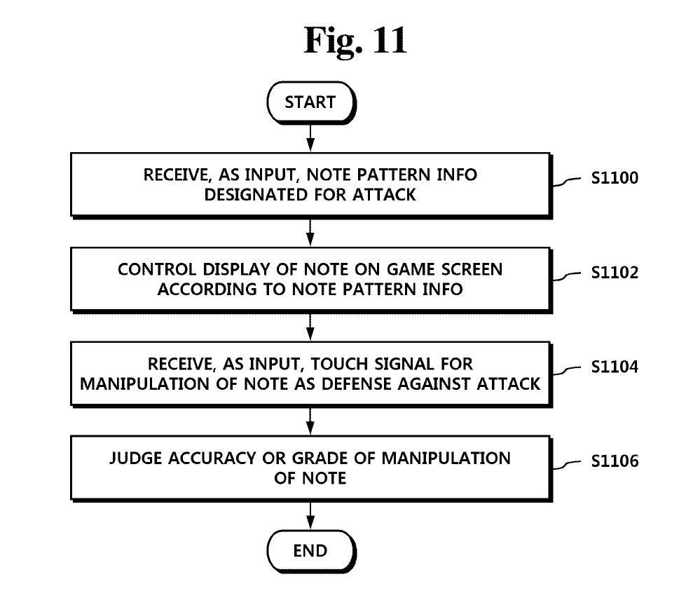

Hereinafter, a method for providing a rhythm game by the terminal 100 according to an embodiment of the present invention as described above will be briefly described with reference to FIG. 11.

FIG. 11 is a flowchart illustrating a method for providing a rhythm game by the terminal 100 according to an embodiment of the present invention.

Referring to FIG. 11, a method for providing a rhythm game by the terminal 100 according to an embodiment of the present invention includes: receiving, as input, note pattern information designated for an attack (S1100); controlling the display of a note on the game screen 200 according to the input note pattern information (S1102); receiving, as input, a touch signal for the manipulation of a note as a defense against the attack (S1104); judging an accuracy or a grade of the manipulation of the note based on input information of the touch signal and information on the display of the note (S1106); and the like.

The method for providing the rhythm game according to an embodiment of the present invention as described above with reference to FIG. 1 to FIG. 11 may be implemented by a program, and may be recorded in a recording medium readable by a computer (including the terminal 100).

A program recorded in a recording medium for implementing the method for providing the rhythm game according to an embodiment of the present invention implements, a function of receiving, as input, note pattern information designated for an attack; a function of controlling the display of a note on the game screen 200 according to the input note pattern information; receiving, as input, a touch signal for the manipulation of a note as a defense against the attack; a function of judging an accuracy or a grade of the manipulation of the note based on input information of the touch signal and information on the display of the note; and the like.

A program recorded in a recording medium may be read, be installed and be executed by a computer, so as to enable the execution of the functions as described above.

In order to read a program recorded in a recording medium and execute functions implemented by the read program by a computer, as described above, the program may include a code coded by using computer languages such as C, C++, JAVA, machine language, etc., which a processor (CPU) of the computer can read through a device interface of the computer.

Such a code may include a function code related to a function, etc., which define the functions as described above, and may include a control code related to an execution procedure that the processor of the computer needs to execute the functions as described above according to a predetermined procedure.

Also, such a code may further include a code related to at which location (address) reference must be made to additional information or a medium, which the processor of the computer needs to execute the functions as described above, in an internal memory or an external memory of the computer.

Also, when the processor of the computer needs communication of itself with another remote computer, server or the like to execute the functions as described above, such a code may further include a code related to how the processor of the computer must communicate with another remote computer, server or the like by using a communication module of the computer, what information or medium the processor of the computer must transmit/receive during the communication, and the like.

The computer-readable recording medium for recording a program as described above, for example, may include a ROM (Read Only Memory), a RAM (Random Access Memory), a CD-ROM (Compact Disc Read Only Memory), a magnetic tape, a floppy disc, an optical media storage device, etc.

Also, the computer-readable storage mediums are distributed in a computer system connected to a network, so that computer-readable codes may be stored in the distributed storage mediums and be executed in a distributed scheme. In this case, any one or more computers of multiple distributed computers execute(s) some of the functions as described above, and may transmit a result of the execution to one or more of the other distributed computers. A computer which receives the transmitted result of the execution may also execute some of the functions as described above, and may also provide a result of the execution to the other distributed computers.

Further, a functional program for implementing the present invention, and a code, code segments, etc. related to this functional program may be easily conceived or changed by programmers in the technical field of the present invention in consideration of a system environment, etc. of a computer, in which a recording medium is read and reading of the recording medium executes a program.

The method, the terminal 100 and the recording medium for providing a rhythm game according to an embodiment of the present invention as described above, relate to the rhythm game in which note pattern information designated for an attack is received as input, and a note displayed according to the received note pattern information is manipulated, so as to defend against the attack.

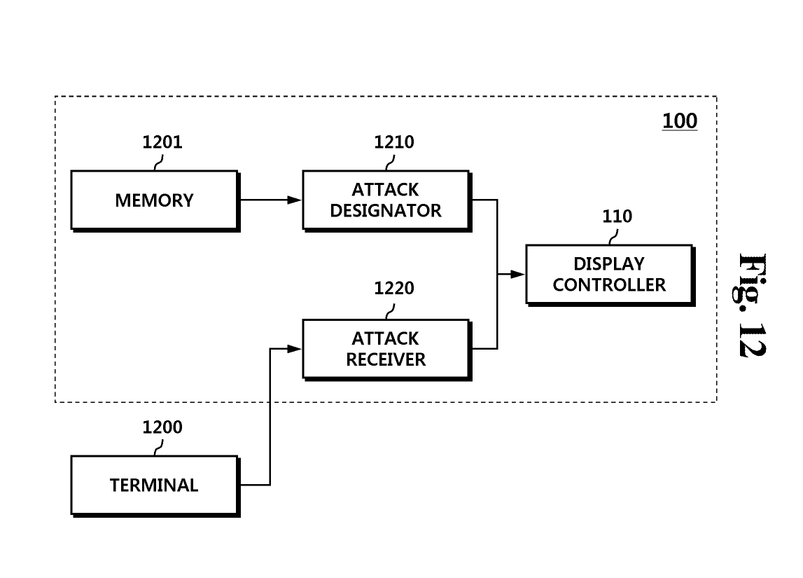

Hereinafter, a main agent which designates note pattern information and performs an attack, will be described with reference to FIG. 12.

FIG. 12 is a view illustrating a scheme for receiving, as input, note pattern information designated for an attack.

Referring to FIG. 12, the terminal 100 for providing a rhythm game according to an embodiment of the present invention, may further include an attack designator 1210, which extracts note pattern information from among multiple pieces of note pattern information previously stored in a memory 1201 according to a predetermined reference, and provides the extracted note pattern information to the display controller 110. Otherwise, the terminal 100 may further include an attack receiver 1220, which receives note pattern information from another terminal 1200 for designating and transmitting note pattern information, and provides the received note pattern information to the display controller 110.

When the display controller 110 receives, as input, note pattern information, from the internal attack designator 1210, the attack designator 1210 of the terminal 100 becomes an attacker, and a user of the terminal 100 becomes a defender, so that a rhythm game having a system of competition between a computer and a user proceeds.

When the display controller 110 receives, as input, note pattern information from the terminal 1200 of another user, another user becomes an attacker, and the user of the terminal 100 becomes a defender, so that a rhythm game having a system of competition between users proceeds.

The terminal 100 enables the user to select a system of competition from a system of competition between a computer and a user, and a system of competition between users, so that the user who has selected a desired system of competition can enjoy the rhythm game.

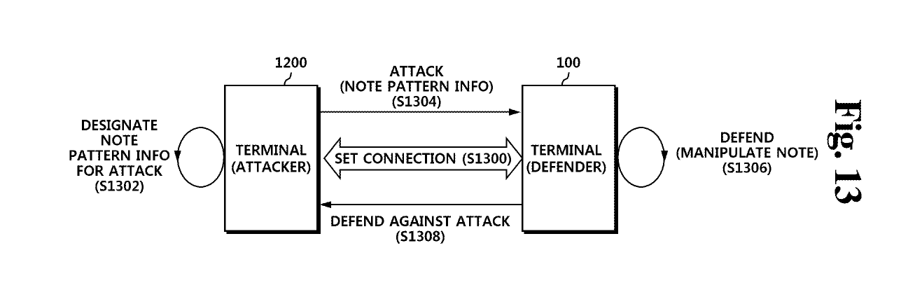

As described above, when a rhythm game having a system of competition between users proceeds between the terminal 1200 of the attacker and the terminal 100 of the defender, a process of the game is schematically illustrated in FIG. 13.

FIG. 13 is a view schematically illustrating a process of playing a rhythm game having a system of competition between users.

Referring to FIG. 13, for a rhythm game having a system of competition between users, a connection between the terminal 1200 of an attacker and the terminal 100 of a defender is set (S1300).

Such a scheme for setting a connection may be a scheme for directly connecting the terminal 1200 of the attacker and the terminal 100 of the defender without going through a service server, an access point, or the like. Otherwise, the scheme may be a scheme for connecting the terminal 1200 of the attacker and the terminal 100 of the defender to each other through a service server, an access point, or the like.

After the connection is set as described above, the terminal 1200 of the attacker designates note pattern information for an attack (S1302), and transmits the designated note pattern information to the terminal 100 of the defender, so as to perform the attack (S1304).

After receiving the note pattern information and constructing a game screen on which a note is displayed according to the received note pattern information, the terminal 100 of the defender allows the user, who views a game screen, to manipulate a note and allows the user to input a touch signal. Then, the terminal 100 of the defender judges the manipulation of the note by using the input touch signal (S1306). Herein, the manipulation of a note displayed according to the received pattern information has a meaning as a defense against an attack.

The terminal 100 of the defender may transmit, to the terminal 1200 of the attacker, information on how well a defense has been performed against an attack through the manipulation of a note, and may notify how well the defense has been performed against the attack through the manipulation of the note (S1308).

Next, a description will be made of a method, a terminal 1200 and a recording medium for providing a rhythm game from the aspect of attack in the rhythm game having a system of competition between users.

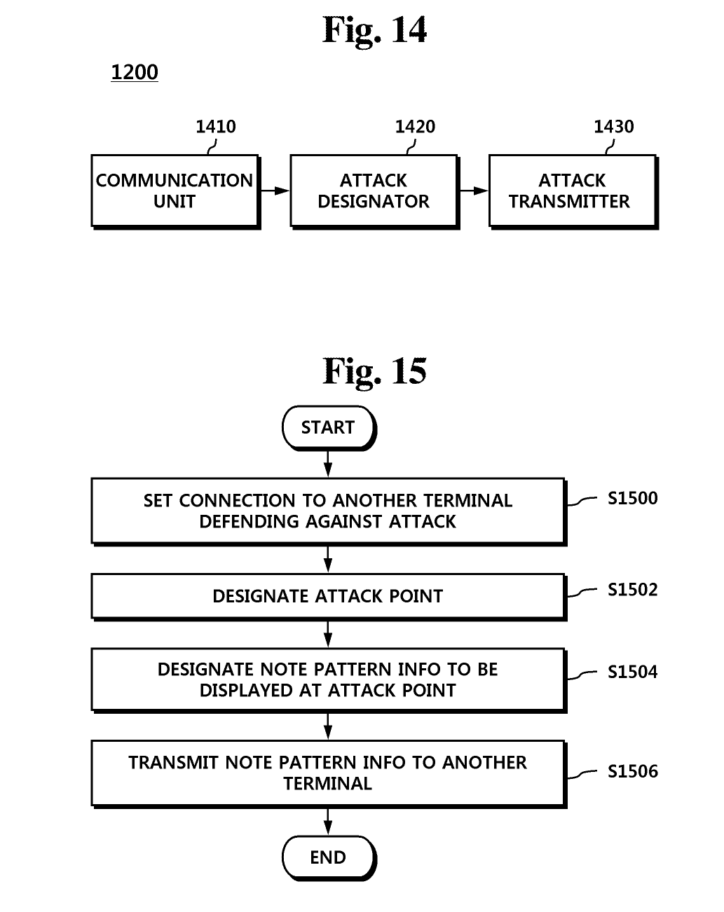

FIG. 14 is a block diagram illustrating the configuration of a terminal 1200 for providing a rhythm game according to another embodiment of the present invention.

Referring to FIG. 14, the terminal 1200 for providing a rhythm game according to another embodiment of the present invention includes: a communication unit 1410 for setting a connection to the terminal 100 of a defender which defends against an attack; an attack designator 1420 for designating one or more attack points for the attack (this attack point becomes a defense point from the viewpoint of a defender) among multiple points on a game screen (which is a game screen of the terminal 1200, and may be identical to the game screen of the terminal 100), and for designating note pattern information on one or more notes to be displayed at the one or more designated attack points according to game setting information (e.g. user input information, a difficulty level, or the like), etc.; an attack transmitter 1430 for transmitting the designated note pattern information to the terminal 100 of the defender; and the like.

The designated note pattern information as described above may include one or more of note position information, information on the number of notes, information on types of notes, information on a scheme for displaying a note, etc. The terminal 100 of the defender may display a note on the game screen 200 according to this note pattern information.

If the user of the terminal 1200 becomes a defender and enjoys the rhythm game, the terminal 1200 includes the display controller 110 included in the terminal 100 of the defender, the touch signal input unit 120, the judgment unit 130, the generator 140 of information on a defense rate against attacks, the attack designator 1210, the attack receiver 1220, etc.

Namely, because a user does not always perform only an attack or a defense, a terminal should include all configurations for a defense and an attack.

Specifically, the terminal for the rhythm game disclosed in this specification should include both the elements 110, 120, 130, 140, 1210 and 1220 of the terminal of the defender as shown in FIG. 1 and FIG. 12, and the elements 1410, 1420 and 1430 of the terminal of the attacker as shown in FIG. 14.

FIG. 15 is a flowchart illustrating a method for providing a rhythm game by the terminal 1200 according to another embodiment of the present invention.

Referring to FIG. 15, a method for providing a rhythm game by the terminal 1200 according to another embodiment of the present invention includes: setting a connection to a terminal 100 of a defender defending against an attack (S1500); designating one or more attack points for the attack among multiple points on a game screen (S1502); designating note pattern information on one or more notes to be displayed at the one or more designated attack points (S1504); transmitting the designated note pattern information to the terminal 100 of the defender (S1506); and the like.

The method for providing a rhythm game according to another embodiment of the present invention as described above may be implemented by a program, and may be recorded in a recording medium readable by a computer (including the terminal 1200 shown in FIG. 14).

A program recorded in a recording medium for implementing the method for providing the rhythm game according to another embodiment of the present invention implements, a function of setting a connection to a terminal of a defender defending against an attack; a function of designating one or more attack points for the attack among multiple points on a game screen; a function of designating note pattern information on one or more notes to be displayed at the one or more designated attack points; a function of transmitting the designated note pattern information to the terminal of the defender; and the like.

A program recorded in a recording medium may be read, be installed and be executed by a computer, so as to enable the execution of the functions as described above.

In order to read a program recorded in a recording medium and execute functions implemented by the read program by a computer, as described above, the program may include a code coded by using computer languages such as C, C++, JAVA, machine language, etc., which a processor (CPU) of the computer can read through a device interface of the computer.

Such a code may include a function code related to a function, etc., which define the functions as described above, and may include a control code related to an execution procedure that the processor of the computer needs to execute the functions as described above according to a predetermined procedure.

Also, such a code may further include a code related to at which location (address) reference must be made to additional information or a medium, which the processor of the computer needs to execute the functions as described above, in an internal memory or an external memory of the computer.

Also, when the processor of the computer needs communication of itself with another remote computer, server or the like to execute the functions as described above, such a code may further include a code related to how the processor of the computer must communicate with another remote computer, server or the like by using a communication module of the computer, what information or medium the processor of the computer must transmit/receive during the communication, and the like.

The computer-readable recording medium for recording a program as described above, for example, may include a ROM (Read Only Memory), a RAM (Random Access Memory), a CD-ROM (Compact Disc Read Only Memory), a magnetic tape, a floppy disc, an optical media storage device, etc.

Also, the computer-readable storage mediums are distributed in a computer system connected to a network, so that computer-readable codes may be stored in the distributed storage mediums and be executed in a distributed scheme. In this case, any one or more computers of multiple distributed computers execute(s) some of the functions as described above, and may transmit a result of the execution to one or more of the other distributed computers. A computer which receives the transmitted result of the execution may also execute some of the functions as described above, and may also provide a result of the execution to the other distributed computers.

Further, a functional program for implementing the present invention, and a code, code segments, etc. related to this functional program may be easily conceived or changed by programmers in the technical field of the present invention in consideration of a system environment, etc. of a computer, in which a recording medium is read and reading of the recording medium executes a program.

According to the present invention as described above, a rhythm game where attacks and defenses can be performed is provided, so as to increase interest in the rhythm game.

Also, according to the present invention, types of notes, a scheme for displaying a note and the like are diversified, so as to increase interest in the rhythm game.

Although it has been described in the above that all the components of an embodiment of the present invention are coupled as a single unit or coupled to be operated as a single unit, the present invention is not necessarily limited to such an embodiment. That is, within the purpose of the present invention, one or more components among the components may be selectively coupled to be operated as one or more units. In addition, although each of the components may be implemented as an independent hardware, some or all of the components may be selectively combined with each other, so that they may be implemented as a computer program having one or more program modules for performing some or all of the functions combined in one or more hardwares. Codes and code segments forming the computer program can be easily conceived by an ordinarily skilled person in the technical field of the present invention. Such a computer program may implement the embodiments of the present invention by being stored in a computer-readable medium, and being read and executed by the computer. Storage mediums for storing the computer program may include a magnetic recording medium, an optical recording medium, etc.

In addition, since terms, such as “including,” “comprising,” and “having” mean that one or more corresponding components may exist unless they are specifically described to the contrary, it shall be construed that one or more other components can be further included. All of the terminologies including one or more technical or scientific terminologies have the same meanings that those having ordinary knowledge in the technical field of the present invention understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and it should be construed that all of the technical ideas included within the scope equivalent to the claims are included within the right scope of the present invention.

1. A terminal for providing a rhythm game, the terminal comprising:
a display controller for controlling display of a note on a game screen according to note pattern information designated and input for an attack;
a touch signal input unit for receiving as an input a touch signal for manipulation of a note as a defense against the attack; and
a judgment unit for judging an accuracy or a grade of the manipulation of the note based on input information of the touch signal and information on the display of the note.

2. (canceled)

3. (canceled)

4. The terminal as claimed in claim 1, wherein the display controller performs a control operation so as to previously display a button at each of multiple points on the game screen, so as to select one or more defense points of the multiple points according to the input note pattern information, and so as to display the note at each of the one or more selected defense points.

5. The terminal as claimed in claim 4, wherein, with respect to the relevant button and the relevant note displayed at each of the one or more selected defense points, the display controller performs a control operation so as to display the relevant note and the relevant button as concentric circles having different diameters with the relevant defense point as a center, and so as to make a timing when a diameter of one or more of the relevant note and the relevant button changes and the relevant note coincides with the relevant button.

6. (canceled)

7. (canceled)

8. The terminal as claimed in claim 4, further comprising a generator of information on a defense rate against attacks for calculating a frequency of attacks based on the number of notes displayed at the one or more selected defense points, and generating information on a defense rate against attacks based on a result of the judgment of the note displayed at each of the one or more selected defense points and the calculated frequency of attacks and outputting or transmitting the generated information on the defense rate against the attacks.

9. The terminal as claimed in claim 1, wherein the display controller performs a control operation so as to previously display a button at each of multiple points on the game screen, so as to select one or more defense points of the multiple points according to the input note pattern information, and so as to simultaneously or sequentially display two circles as the one note at each of the one or more selected defense points; and
with respect to the button and the two circles displayed at each of the one or more selected defense points, performs a control operation so as to display the relevant button and the two circles as concentric circles having different diameters with the relevant defense point as a center, so as to make a first timing when a diameter of a first circle of the two circles changes and the first circle coincides with the relevant button, and so as to make a second timing when after the first timing, a diameter of a second circle of the two circles changes and the second circle coincides with the relevant button.

10. (canceled)

11. (canceled)

12. The terminal as claimed in claim 1, wherein the display controller selects two or more defense points of multiple points on the game screen according to the input note pattern information, and displays the note corresponding to one long note obtained by connecting the two or more selected defense points.

13. The terminal as claimed in claim 12, wherein the judgment unit determines whether the touch signal has been continuously input along a display trajectory of the long note, based on the input information of the touch signal and the information on the display of the note, or determines whether touch signals have been sequentially generated and have been input through buttons existing on a trajectory of the long note, respectively when a button is previously displayed at each of multiple points on the game screen, and judges an accuracy or a grade of the manipulation of the note according to a result of the determination.

14. The terminal as claimed in claim 13, further comprising a generator of information on a defense rate against attacks for generating and outputting information on a defense rate against attacks based on a result of the judgment of the long note, and wherein when the two or more selected defense points are connected and the two or more connected defense points are displayed as one long note by the display controller, the total number of nodes, each of which represents between two points in all long notes displayed according to the note pattern information, is equal to or smaller than a predefined maximum frequency of attacks

15. The terminal as claimed in claim 1, wherein, according to the input note pattern information, the display controller controls the display of the note so as to display the note as a circle, and so as to make a timing when a shape of the note becomes a straight line while the shape of the note changes from the circle to a circular arc and becomes smaller in an area of the circular arc with lapse of time.

16. (canceled)

17. The terminal as claimed in claim 15, wherein, according to the input note pattern information, the display controller controls the display of multiple notes so as to display each of the multiple notes as a circle, and so as to make a straight line timing when all generated straight lines are displayed on a straight line while a shape of each of the multiple notes changes from the circle to a circular arc and becomes smaller in an area of the circular arc, with lapse of time.

18. The terminal as claimed in claim 17, wherein the judgment unit determines how close a time point, when the touch signal has begun to be input, is to the straight line timing and whether the touch signal is continuously input along straight line within a predetermined time period, based on the input information of the touch signal and the information on the display of the note, and judges an accuracy or a grade of the manipulation of the note according to a result of the determination.

19. The terminal as claimed in claim 18, further comprising a generator of information on a defense rate against attacks for calculating a sum of straight line lengths of the multiple notes on the straight line as an attack length and calculating, as a defense length, a length in which the touch signal is continuously input along the straight line within a predetermined time period, based on the input information of the touch signal and the information on the display of the note, and generating information on a defense rate against attacks based on the calculated attack length and the calculated defense length and outputting or transmitting the information on the defense rate against the attacks.

20. A method for providing a rhythm game by a terminal, the method comprising:
receiving, as an input, note pattern information designated for an attack;
controlling display of a note on a game screen according to the input note pattern information;
receiving as an input a touch signal for manipulation of a note as a defense against the attack; and
judging an accuracy or a grade of the manipulation of the note based on input information of the touch signal and information on the display of the note.

21. (canceled)

22. (canceled)

23. (canceled)

24. A method for providing a rhythm game by a terminal, the method comprising:
setting a connection to a terminal of a defender defending against an attack;
designating one or more attack points for the attack among multiple points on a game screen;
designating note pattern information on one or more notes to be displayed at the one or more designated attack points; and
transmitting the designated note pattern information to the terminal of the defender.

25. (canceled)
